(19) United States
(12) Patent Application Publication
(10) Pub. No.: US 2011/0317772 A1
(43) Pub. Date: Dec. 29, 2011

(54) COMMUNICATION APPARATUS AND CONTROL METHOD THEREFOR

(75) Inventors: Hirohiko Inohiza, Rennes (FR); Ichiro Kuwana, Tokyo (JP)

(73) Assignee: CANON KABUSHIKI KAISHA, Tokyo (JP)

(21) Appl. No.: 13/255,481

(22) PCT Filed: Mar. 2, 2010
(86) PCT No.: PCT/JP2010/001412

§ 371 Date: Sep. 8, 2011

(30) Foreign Application Priority Data
Mar. 12, 2009 (JP) 2009-059562

(51) Int. Cl. H04N 7/26

(52) U.S. Cl. 375/240.25; 375/240.01; 375/E07.026; 375/E07.027

(57) ABSTRACT

Regarding an apparatus capable of transmitting data using a high-rate transmission channel having narrow directivity and a low-rate transmission channel having wide directivity, data is not correctly sent in some cases because a communication path for the high-rate transmission channel is easily interrupted. In contrast, paths for the low-rate transmission channel are less likely to be interrupted than a path for the high-rate transmission channel. Compressed data is transmitted via the low-rate transmission channel, and loss data that is lost by compression is transmitted via the high-rate transmission channel. An apparatus on a reception side combines, with the loss data, data that is obtained by decompressing the compressed data, and output the combined data. When the loss data cannot be received, the apparatus outputs the data that is obtained by decompressing the compressed data.

### TECHNICAL FIELD

The present invention relates to a communication technology for transmitting a data item such as a video data item.

### BACKGROUND ART

As a technology for transmitting a video data item or an audio data item, a millimeter-wave wireless technology using a 60-GHz band, which can utilize a broad bandwidth and which can realize high-speed wireless transmission, has drawn attention. A millimeter wave has properties that are similar to those of light, and has a high rectilinear-propagation property. In millimeter-wave wireless communication, because of the characteristics of a millimeter wave, communication is easily interrupted when a shielding object such as a human crosses a communication path.

In a WirelessHD specification that is a standard specification of the millimeter-wave communication technology, an HRP (High Rate PHY) that is a high-rate transmission channel and an LRP (Low Rate PHY) that is a low-rate transmission channel are defined. Regarding the HRP, an antenna having narrow directivity is used. Accordingly, the direction of arrival of a millimeter wave associated with communication paths is limited, but a high gain can be obtained. The HRP is used to transmit a data item, such as an uncompressed video data item, at a high rate. On the other hand, regarding the LRP, the rate is low, and an antenna having wide directivity is used. Accordingly, when the LRP is compared with the HRP, the direction of arrival of a millimeter wave associated with communication paths is not limited, and a communication path is not easily interrupted. The LRP is used to transmit a compressed video data item, a control data item, and so forth. Furthermore, in WirelessHD, when interruption of a communication path is detected, a scheme is employed, in which switching to another communication path is performed by utilizing reflection of a millimeter wave at a wall or the like, and in which communication is restored.

As described above, in WirelessHD, proper use of the HRP and the LRP is realized by selecting either one of the channels, namely, the HRP and the LRP. Furthermore, when interruption of a communication path is detected, switching among communication paths is performed. In this manner, WirelessHD copes with the above-described problem of a millimeter wave.

### CITATION LIST

### Non Patent Literature

NPL 1: WirelessHD Specification Version 1.0 Overview (http://www.wirelesshd.org/pdfs/WirelessHD_Full_Overview_{—}071009.pdf)

### SUMMARY OF INVENTION

### Technical Problem

However, even when transmission of an uncompressed video data item using a high-rate transmission channel is attempted as in the case of transmission using WirelessHD, a case is considered, in which it is not possible to ensure a data rate with which the uncompressed video data item can be transmitted for the high-rate transmission channel. In this case, only the following methods can be available: a method in which the video data item is compressed; and a method in which a video data item including only a low-frequency element, the degree of importance of the low-frequency element being high, is selected thereby reducing image quality, and in which the selected video data item is transmitted. Furthermore, when interruption of a communication path is detected while a video data item is being transmitted and switching among communication paths is performed, instability occurs for a short moment during replaying of a video. Thus, there is a problem of the reliability of communication.

The present invention provides, when transmission of a data item, such as a video data item, is performed between communication apparatuses, prevention of the quality of the data item from being reduced, and prevention of the reliability of communication from being lost.

### Solution to Problem

The present invention provides communication of a compressed video data item, which is obtained by compressing a data item, via a low-rate transmission channel, and communication of a loss data item, which is lost by compression of the data item, via a high-rate transmission channel.

### Advantageous Effects of Invention

According to the present invention, the quality of a data item can be prevented from being reduced, and the reliability of communication can be prevented from being lost.

### BRIEF DESCRIPTION OF DRAWINGS

FIG. 1 is a diagram illustrating an example of a configuration of a system.

FIG. 2 is a block diagram of a sending node.

FIG. 3 is a block diagram of a receiving node.

FIG. 4 is a diagram for explaining control of an antenna.

FIG. 5 is a diagram of a configuration of a communication frame.

FIG. 6 is a diagram of a configuration of a video data item.

FIG. 7 is a sequence diagram of an overall operation of the system (in a case in which reception of an LRP packet and an HRP packet succeeds).

FIG. 8 is a sequence diagram of an overall operation of the system (in a case in which reception of only an LRP packet succeeds).

FIG. 9 includes flowcharts of a video-data transmission process performed by the sending node.

FIG. 10 includes flowcharts of a video-data transmission process performed by the receiving node.

### DESCRIPTION OF EMBODIMENT

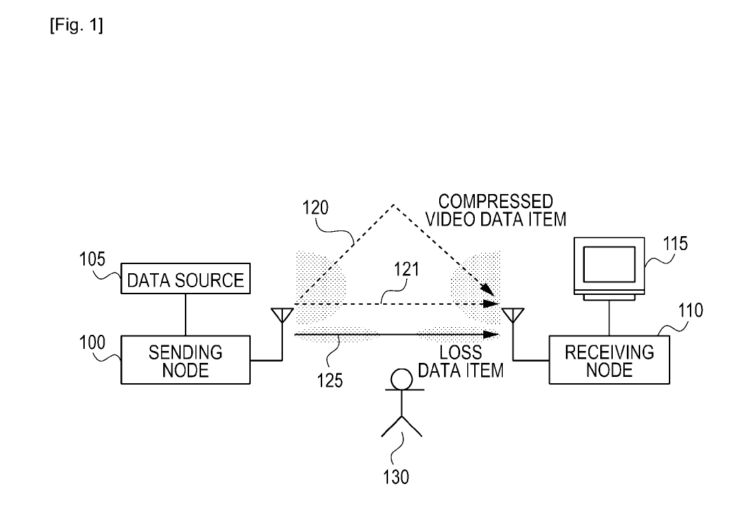

An embodiment of the present invention will be described with reference to the drawings. FIG. 1 is a diagram illustrating an example of a configuration of a wireless communication system according to the present embodiment. In this system, a video data item is wirelessly transmitted between two nodes. WirelessHD (NPL 1) is utilized as a wireless transmission scheme.

A sending node 100 is a communication apparatus that is a source of sending a video data item. The sending node 100 sends, via a wireless link, a video data item that is obtained from a data source 105. Although the sending node 100 is directly connected to the data source 105 in the configuration, the sending node 100 does not necessarily need to be directly connected to the data source 105. A receiving node 110 is a communication apparatus on a side of destination of the video data item. The receiving node 110 outputs the video data item, which has been received via the wireless link, to a display 115 for displaying a video. The nodes in the present embodiment have directional antennas, and can wirelessly transmit a video data item using a high-rate transmission channel (hereinafter, referred to as an “HRP”) and a low-rate transmission channel (hereinafter, referred to as an “LRP”) while switching antenna directivities. Reference numerals 120 and 121 denote communication paths for the LRP, and reference numeral 125 denotes a communication path for the HRP. The same video data item is simultaneously sent along the communication paths for the LRP and the communication path for the HRP. Regarding the LRP, a wireless signal is transmitted at a low rate, but transmitted with a wide directivity. Accordingly, a wireless signal propagates over a wide region, and reaches a receiving node via a plurality of communication paths such as the communication paths 120 and 121. Regarding the HRP, a wireless signal is transmitted at a high rate, but transmitted with a narrow directivity. Accordingly, a direction of arrival of a wireless signal associated with communication paths is limited, and a wireless signal reaches a receiving node via a single communication path such as the communication path 125. Reference numeral 130 denotes a shield object that interrupts a communication path. In the present embodiment, a compressed video data item is transmitted using the LRP, and a loss data item that is lost by compression of a video data item is transmitted using the HRP.

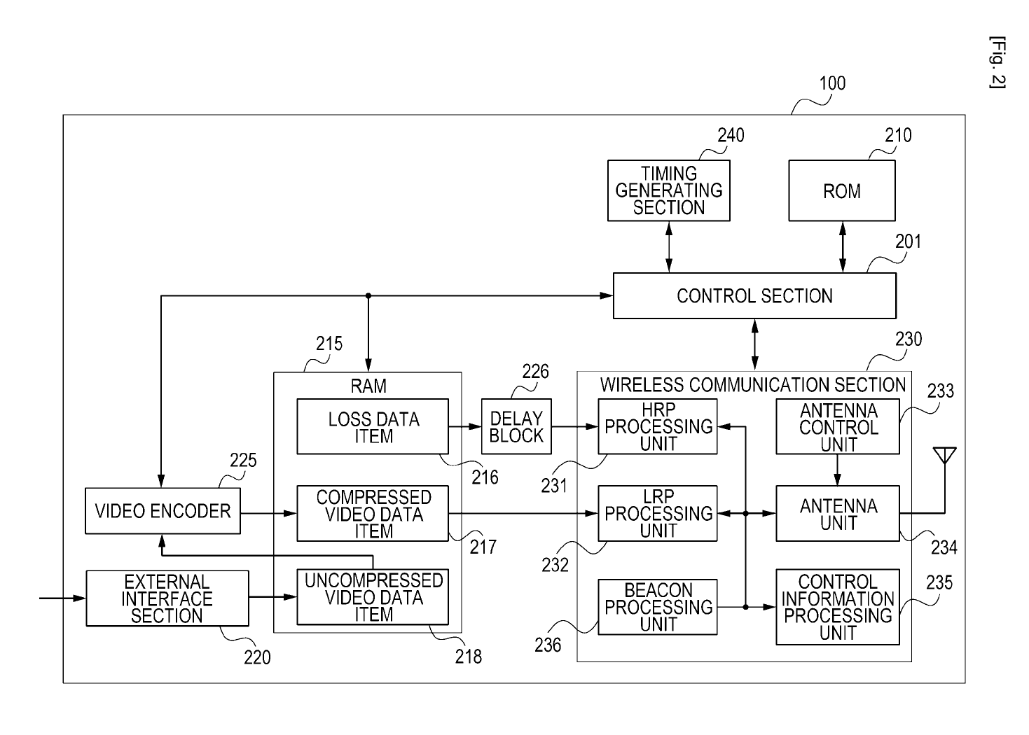

FIG. 2 is a block diagram illustrating an internal configuration of the sending node 100. Reference numeral 201 denotes a control section that controls, by executing a control program which is stored in a ROM 210, an overall operation in the sending node 100. Reference numeral 240 denotes a timing generating section for generating a timing at which a process of sending/receiving wireless data items is performed. Reference numeral 210 is a ROM for storing the control program for the sending node 100 and non-volatile parameters. Reference numeral 215 is a RAM for storing volatile parameters and temporary data items. Reference numeral 218 denotes an uncompressed video data item. Reference numeral 217 denotes a compressed video data item that is obtained by compressing the uncompressed video data item 218. Reference numeral 216 is a loss data item that is a data item which is lost when the uncompressed video data item 218 is compressed. All of the reference numerals 216 to 218 denote data items that are saved in the RAM 215. Reference numeral 220 denotes an external interface section for establishing connection to an external device such as a media player, and for receiving a video data item. Reference numeral 225 denotes a video encoder that generates a compressed video data item from an uncompressed video data item. Reference numeral 226 is a delay block that stores a video encoding processing time, and that delays the loss data item 216, which is to be output, by a predetermined time corresponding to the video encoding processing time (a compression processing time). Reference numeral 230 is a wireless communication section that performs sending/receiving of wireless data items. Reference numeral 232 denotes a first communication unit for performing a process of sending/receiving an LRP packet, which is an LRP processing unit. Reference numeral 231 denotes a second communication unit for performing a process of sending/receiving an HRP packet, which is an HRP processing unit. Reference numeral 234 denotes an antenna unit for sending/receiving wireless signals. Reference numeral 233 denotes an antenna control unit for controlling a directional angle of the antenna unit 234. Reference numeral 235 is a control information processing unit for processing control commands and messages defined in a wireless protocol. Reference numeral 236 denotes a beacon processing unit that manages access information items concerning the entire wireless communication system, and that sends the access information items as a beacon. Access information items, such as a unique word for achieving frame synchronization, an identifier of a node that accesses a wireless medium, and a directional angle of an antenna and a modulation class that are applied for a packet to be sent/received by each of the nodes, are included in a beacon. Here, the modulation class indicates a combination of a modulation scheme and an encoding scheme.

Next, the relationships among the individual blocks in a case in which video data items are sent will be described. The sending node 100 receives the uncompressed video data item 218 via the external interface section 220 from an external device. The video encoder 225 encodes the uncompressed video data item 218, thereby generating the compressed video data item 217. At the same time, the video encoder 225 generates, from the uncompressed video data item 218 and the compressed video data item 217, the loss data item 216 that is a data which is lost when compression is performed. The loss data item 216 is passed to the HRP processing unit 231. Furthermore, the compressed video data item 217 is passed to the LRP processing unit 232. Additionally, in order to guarantee a time difference between a time at which the loss data item 216 is output and a time at which the compressed video data item is output, the loss data item 216 is delayed by the delay block 226 by a delay corresponding to a loss-data generating processing time, and output. The loss data item 216 is stored in an HRP packet by the HRP processing unit 231, and the compressed video data item 217 is stored in an LRP packet by the LRP processing unit 232. Furthermore, access information items concerning the HRP packet and the LRP packet are generated by the beacon processing unit 236, and stored in a beacon. Then, the sending node 100 performs wireless transmission of the beacon, the HRP packet, and the LRP packet while the antenna control unit 233 is controlling the directivity of the antenna unit 234 in accordance with a timing that is generated by the timing generating section 240.

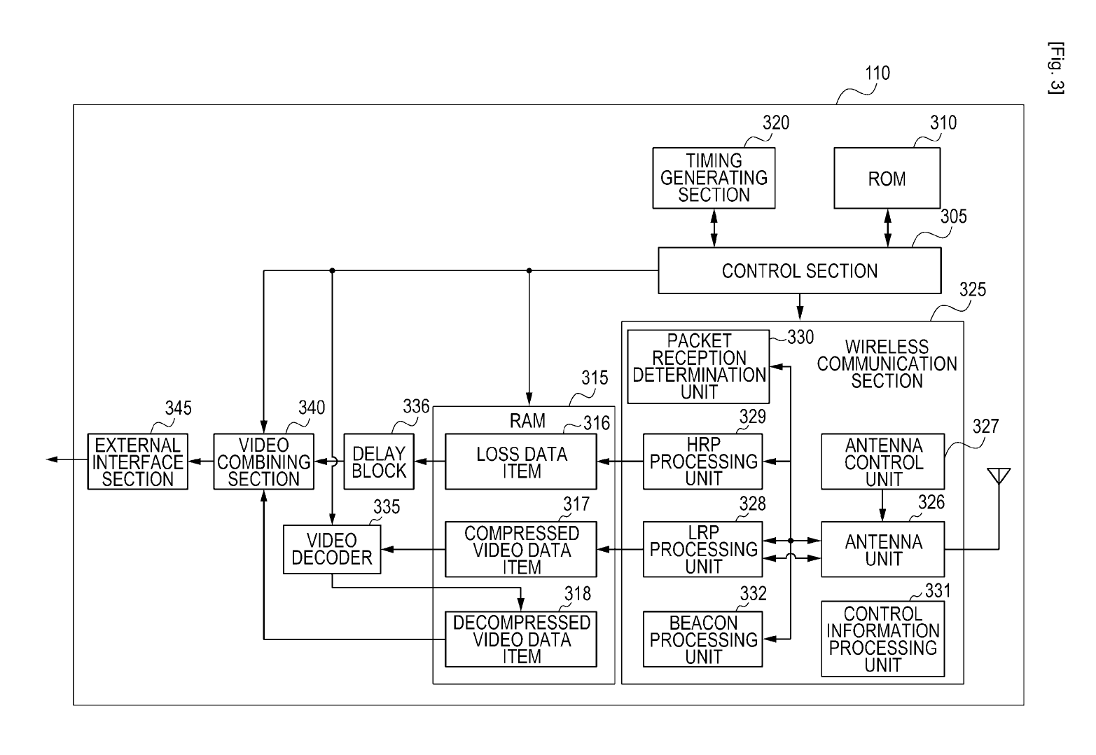

FIG. 3 is a block diagram illustrating an internal configuration of the receiving node 110. Reference numeral 305 denotes a control section that controls, by executing a control program which is stored in a ROM 310, an overall operation in the receiving node 110. Reference numeral 310 is a ROM for storing the control program for the receiving node 110 and non-volatile parameters. Reference numeral 315 is a RAM for storing volatile parameters and temporary data items. Reference numeral 316 is a loss data item. Reference numeral 317 is a compressed video data item. Reference numeral 318 is a decompressed video data item. All of the reference numerals 316 to 318 denote data items that are saved in the RAM 315. Reference numeral 320 denotes a timing generating section for generating a timing at which a process of sending/receiving wireless data items is performed. Reference numeral 325 is a wireless communication section that performs sending/receiving of wireless data items. Reference numeral 326 denotes an antenna unit for sending/receiving wireless signals. Reference numeral 327 denotes an antenna control unit for controlling a directional angle of the antenna unit 326. Reference numeral 329 denotes a first communication unit for performing a process of receiving an HRP packet and a process of measuring a communication quality of an HRP packet, which is an HRP processing unit. Reference numeral 328 denotes a second communication unit for performing a process of sending/receiving an LRP packet and a process of measuring a communication quality of a received LRP packet, which is an LRP processing unit. Reference numeral 330 denotes a packet reception determination unit that performs determination of whether or not an HRP packet and an LRP packet have been correctly received. Reference numeral 331 is a control information processing unit for processing control commands that are defined in a wireless protocol and for processing information items concerning communication qualities that are measured by the receiving node 110. Reference numeral 332 denotes a beacon processing unit that analyzes and processes access information items included in a received beacon. Reference numeral 335 is a video decoder that decompresses the compressed video data item 317, thereby generating the decompressed video data item 318. Reference numeral 336 is a delay block that stores a video decompression processing time, and that delays the loss data item 316, which is to be output, by a predetermined time corresponding to the video decompression processing time. Reference numeral 340 is a video combining section that combines video data items, which are input, with each other. The video combining section 340 combines the decompressed video data item with the loss data item, thereby generating a video data item having a high quality. Reference numeral 345 denotes an external interface section that is connected to an external device, such as a display, and that outputs a video data item.

Next, the relationships among the individual blocks in a case in which video data items are received will be described. The receiving node 110 receives a beacon that has been wirelessly transmitted from the sending node 100. The receiving node 110 receives, in accordance with access information items that are received by the beacon processing unit 332, an HRP packet and an LRP packet while the antenna control unit 327 is controlling the directivity of the antenna unit 326 in accordance with a timing that is generated by the timing generating section 320. Whether the HRP packet and the LRP packet have been received is determined by the packet reception determination unit 330. As a result, when the HRP packet and the LRP packet have been correctly received, the loss data item 316 stored in the HRP packet and the compressed video data item 317 stored in the LRP packet are extracted, and saved in the RAM 315. Then, the compressed video data item 317 is decompressed by the video decoder 335, thereby generating the decompressed video data item 318. When both the HRP packet and the LRP packet have been correctly received, the loss data item 316 and the decompressed video data item 318 are output to the video combining section 340, and combined with each other, thereby generating a video data item having a high quality. The video data item is output to the external interface section 345. In order to guarantee a time difference between a time at which the loss data item 316 is output and a time at which the decompressed video data item 318 is output, the delay block 336 delays the loss data item 316 by a delay corresponding to a decompression processing time taken to generate the decompressed video data item 318 by decompressing the compressed video data item 317, and outputs the loss data item 316 to the video combining section 340. In contrast, when only the LRP packet has been correctly received, only the decompressed video data item 318 is output to the video combining section 340. As a result, the decompressed video data item 318 is output to the external interface section 345. Finally, the external interface section (345) outputs the received video data item to an external device. The external interface section 345 outputs, to an external device, the video data item (the combined video data item or the decompressed video data item) that has been received from the video combining section 340.

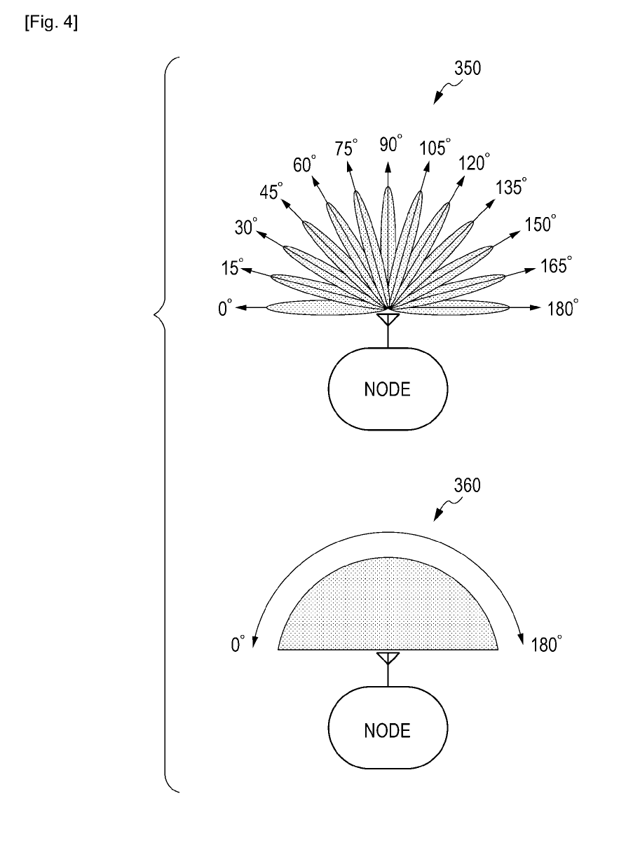

FIG. 4 is a diagram for explaining control of an antenna of each of the nodes. Each of the nodes has an adaptive array antenna, and controls the phase of a wireless signal that is sent/received from an antenna element, whereby a directivity mode can be switched between a narrow-directivity mode 350 and a wide-directivity (Wide) mode 360. In the narrow-directivity mode 350, for example, as illustrated, a directional angle of the antenna is controlled in a range from 0 degrees to 180 degrees with a resolution that is obtained by dividing the range in units of 15 degrees, and a beam can be formed in accordance with the directional angle of the antenna. With the narrow-directivity mode 350, when a wireless signal is sent/received, a high gain can be obtained. However, the range of available communication paths is limited. In this example, the above-mentioned configuration is used for easy understanding. However, the range of the directional angle of the antenna and the resolution of the directional angle of the antenna in the narrow-directivity mode 350 are not limited thereto. In the Wide mode 360, for example, as illustrated, a wide directional angle having a range from 0 degrees to 180 degrees is controlled. However, as in the narrow-directivity mode 350, the range of the directional angle is not limited thereto. When a wireless signal is sent/received, a gain in the Wide mode 360 is lower than that in the narrow-directivity mode 350. However, the range of available communication paths is wider. In this example, at least either one of the sending node and the receiving node performs sending/receiving of an HRP packet in the narrow-directivity mode 350, and performs sending/receiving of an LRP packet whose data capacity is small in the Wide mode 360.

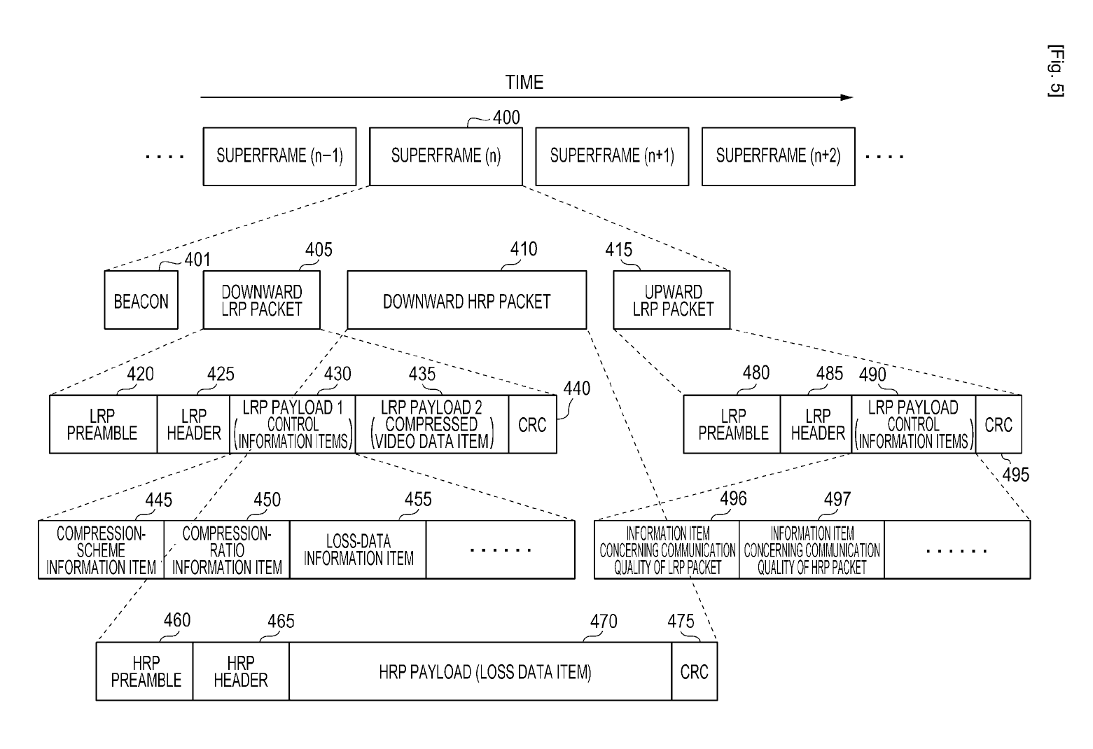

FIG. 5 is a diagram illustrating a configuration of a superframe 400 that is an example of a communication frame in the wireless communication system according to the present embodiment. The superframe 400 is sent with a certain repeated cycle in a time period in which video data items are available. The superframe 400 includes a beacon 401, a downward LRP packet 405, a downward HRP packet 410, and an upward LRP packet 415. Here, the terms “downward” and “upward” are expressions indicating communication directions between two nodes. A communication direction from the sending node 100 to the receiving node 110 is defined as a “downward” direction, and a communication direction from the receiving node 110 to the sending node 100 is defined as an “upward” direction. The sending node 100 sends the beacon 401, the downward LRP packet 405, and the downward HRP packet 410. With the downward LRP packet 405, the sending node 100 sends control information items and a compressed video data item. With the downward HRP packet 410, the sending node 100 sends a loss data item. The receiving node 110 sends the upward LRP packet 415, thereby sending control information items concerning communication qualities of a downward LRP packet and a downward HRP packet, and so forth. In the present embodiment, because one-way communication of video data items is supposed, the upward LRP packet is not included in the superframe 400. However, in a case of two-way communication, the upward LRP packet is also included in the superframe 400. Furthermore, a method for arranging the packets is not limited thereto. For example, the packets may be arranged so that the upward LRP packet will be a first packet in a sequence of the packets.

Information elements included in each of the packets will be described. Access information items, such as a unique word for achieving frame synchronization, an identifier of a node that accesses a wireless medium, and a directional angle of an antenna and a modulation class that are applied for a packet to be sent/received by each of the nodes, are included in the beacon 401. The receiving node 110 receives the beacon 401, and achieves frame synchronization. In addition, the receiving node 110 receives data packets that have been sent using the LRP and the HRP from the sending node 100 by controlling the directional angle of the antenna and the modulation class in accordance with the access information items included in the beacon 401. The receiving node 110 sends an upward LRP packet. The downward LRP packet 405 is a packet with which the sending node 100 sends control information items and a compressed video data item. A known signal for achieving symbol synchronization with respect to a symbol included in the downward LRP packet 405 is included in an LRP preamble 420. Information items concerning the entire downward LRP packet 405, such as the number of payloads included in the downward LRP packet 405 and lengths of the individual payloads, are included in an LRP header 425. Control information items are included in a downward LRP payload 1 (430). The control information items include a compression-scheme information item 445 for a compressed video data item, a compression-ratio information item 450, a loss-data information item 455, a control command for path search, a training sequence in a case of path search, and so forth. The training sequence indicates a known signal that is used to measure communication qualities of communication paths using combinations of predetermined directional angles of a sending antenna and directional angles of a receiving antenna. The receiving node performs decompression of a received compressed video data item in accordance with the compression-scheme information item 445 and the compression-ratio information item 450. Regarding the information items, values are set depending on an available communication band and data rates that are available for the LRP and the HRP. The loss-data information item is a control information item indicating which information item included in an original uncompressed video data item corresponds to a loss data item that the sending node transmits using the HRP. The receiving node 110 combines a decompressed data item with a loss data item in accordance with the loss-data information item 455. A compressed video data item is included in a downward LRP payload 2 (435). A CRC 440 is a sign for detecting an error in the downward LRP packet 405.

The downward HRP packet 410 is a packet with which the sending node 100 sends a loss data item. A known signal for achieving symbol synchronization with respect to a symbol included in the downward HRP packet 410 is included in an HRP preamble 460. Information items concerning the entire downward HRP packet 410, such as the number of payloads included in the downward HRP packet 410 and lengths of the individual payloads, are included in an HRP header 465. The entirety or a portion of a loss data item is included in a downward HRP payload 470. Which information item included in an original uncompressed video data item corresponds to a loss data item that is stored in the HRP payload 470 is specified with the loss-data information item 455 stored in the control information items included in the downward LRP packet 405. A CRC 475 is a sign for detecting an error in the downward HRP packet 410. The upward LRP packet 415 is sent by the receiving node 110, and is a packet with which control information items are sent. A known signal for achieving symbol synchronization with respect to a symbol included in the upward LRP packet 415 is included in an LRP preamble 480. Information items concerning the entire upward LRP packet 415, such as the number of payloads included in the upward LRP packet 415 and lengths of the individual payloads, are included in an LRP header 485. Control information items are included in an upward LRP payload 490. The control information items include an information item 496 concerning a communication quality of an LRP packet and an information item 497 concerning a communication quality of an HRP packet, which have been measured by the receiving node 110, a control command for path search, and the training sequence in a case of path search, and so forth. As an information item concerning a communication quality, an information item indicating an RSSI (a reception field strength), a CINR (a ratio of a carrier-wave power to an interference noise power), or the like is used. RSSI stands for Received Signal Strength Indicator. CINR stands for Carrier to Interface and Noise Ratio. A CRC 495 is a sign for detecting an error in the upward LRP packet 415.

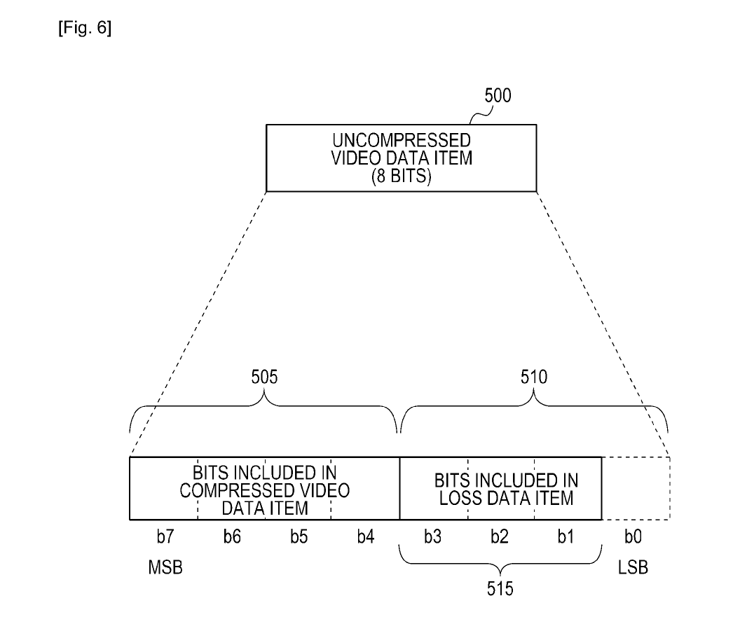

FIG. 6 is a diagram of a configuration of a video data item. Reference numeral 500 denotes an uncompressed video data item, and each uncompressed video data item includes eight bits. The individual bits indicate different data items concerning frequency elements of a video. The further toward the most significant bit a bit is located, the lower the frequency of the element indicated by the bit. The further toward the most significant bit a bit is located, the higher the degree of significance of the bit. Furthermore, the further toward the least significant bit a bit is located, the higher the frequency of the element indicated by the bit. The further toward the least significant bit a bit is located, the lower the degree of significance of the bit. Reference numeral 505 denotes bits included in a compressed video data item that is obtained as a result of compression of the uncompressed video data item 500. In this example, it is indicated that the compressed video data item includes the upper four bits, and the lower four bits are lost by a compression process. Reference numeral 510 denotes a loss data item that includes the lower four bits, and is a data item transmitted using an HRP packet. Note that the loss data item is an uncompressed data item because it is a data item that is lost by the compression process. For this reason, it is not necessarily possible to transmit the entire loss data item using an HRP packet. When it is not possible to transmit the entire loss data item using an HRP packet, a portion of the loss data item (a transmissible portion of the loss data item that is determined from the upper side) is transmitted. For example, when the communication quality of an HRP packet is low and it is not possible to ensure a sufficient communication band, the transmission capacity of the HRP packet is reduced. Accordingly, a case is considered, in which only a portion of the loss data item can be transmitted. Alternatively, when a compression ratio that is used when the video data item is compressed is high, the capacity of the loss data item is increased. Accordingly, a case is considered, in which only a portion of the loss data item can be transmitted. When transmission of a portion of the loss data item using an HRP packet is performed, it is necessary to specify, for the receiving node 110, which bit included in the original uncompressed video data item 500 corresponds to the loss data item. The loss-data information item 455 stored in the control information items included in the downward LRP packet illustrated in FIG. 5 is used for the specification. For example, the loss-data information item is considered as an eight-bit bitmap. It is supposed that each of bits included in the bitmap is assigned to a corresponding one of the bits included in the uncompressed video data item that is transmitted as the loss data item using an HRP packet. In this case, when transmission of a loss data item 515 illustrated in FIG. 6 is performed, 0b00001110 can be stored in the loss-data information item. Furthermore, notification of whether the loss data item 515 is the entire loss data item or a portion of the loss data item is performed in accordance with the loss-data information item 455. As a matter of course, the loss-data information item is an example of an information item indicating which portion of an uncompressed video data item corresponds to a loss data item. The format is not limited thereto, and any format with which a loss data item can be identified can be used. Furthermore, the number of bits included in an uncompressed video data item and the number of bits included in a loss data item are not limited thereto.

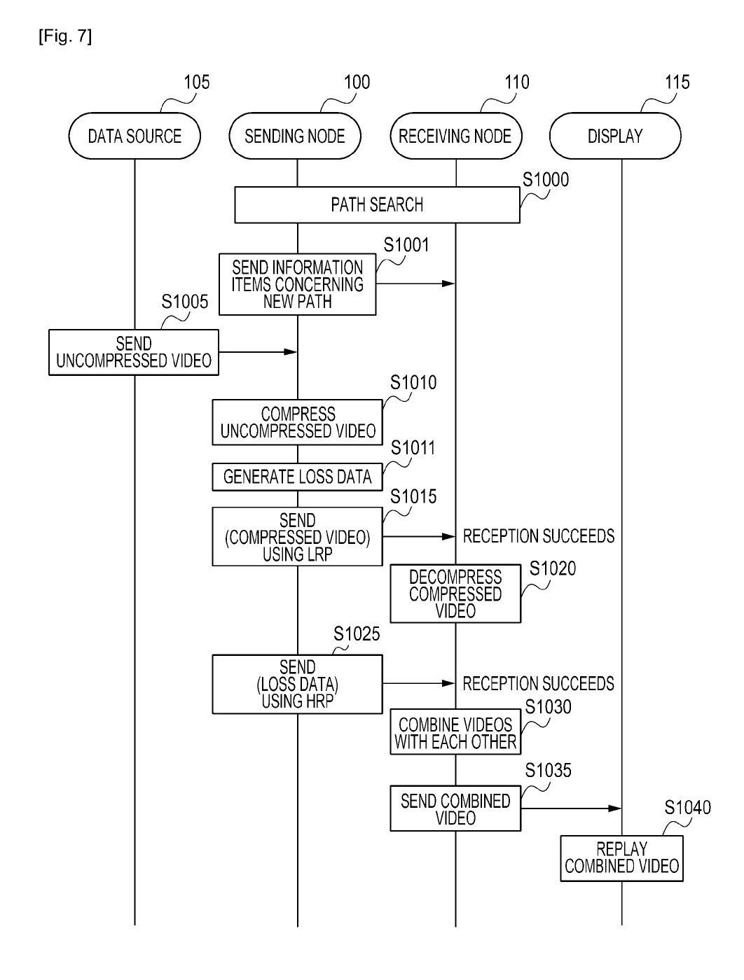

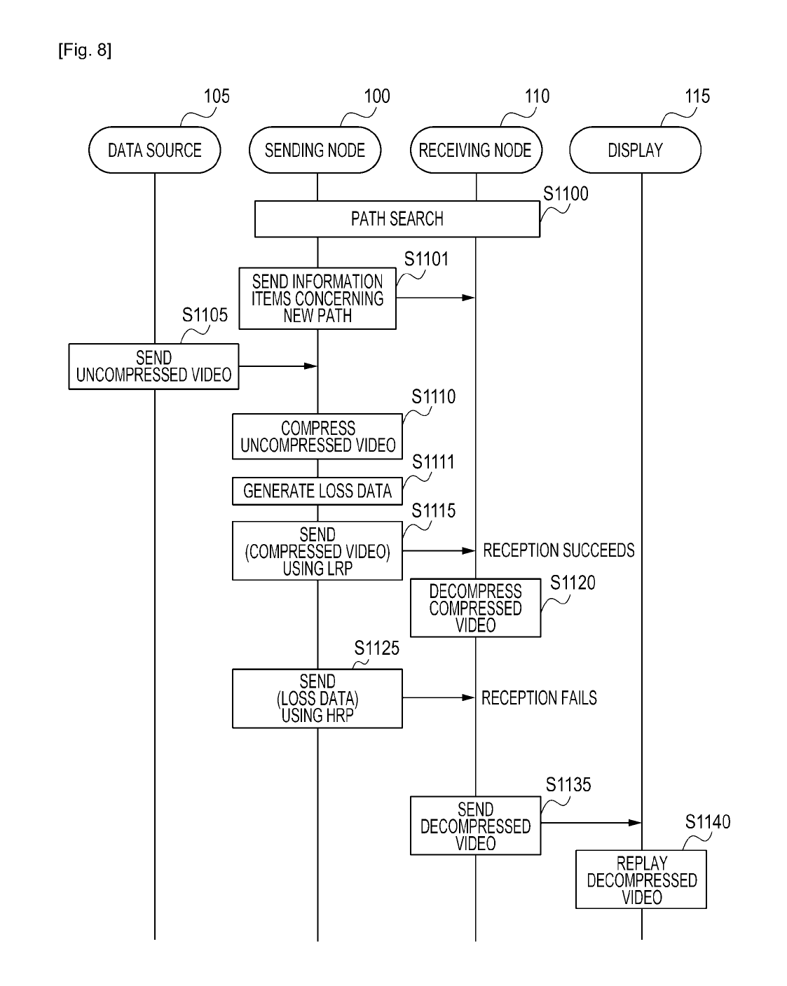

Operations of controlling the entire system will be described with reference to sequence diagrams illustrated in FIGS. 7 and 8.

In a sequence from S1000 to S1040 illustrated in FIG. 7, a process performed in a case in which the receiving node 110 can correctly receive both an HRP packet and an LRP packet is illustrated.

Prior to transmission of video data items, in order to perform search of a communication path that is most appropriate for transmission of an HRP packet and to perform determination of modulation classes for an LRP packet and the HRP packet, the sending node 100 and the receiving node 110 perform a path search process (S1000). In the path search process, measurement of communication qualities of communication paths using combinations of predetermined directional angles of the sending antenna and directional angles of the receiving antenna is performed using the training sequence. A communication path that is most appropriate for transmission of video data items is determined in accordance with a result of measurement. Access information items, such as a directional angle of the sending antenna of the sending node 100, a directional angle of the receiving antenna of the receiving node 110, and modulation classes for an HRP packet and an LRP packet, are determined. The determined access information items concerning the new communication path are stored in a beacon, and the beacon is sent. The access information items are shared between the sending node 100 and the receiving node 110 (S1001). Next, the sending node 100 and the receiving node 110 perform transmission of video data items. The data source 105 sends an uncompressed video data item (S1005). The sending node 100 compresses the received uncompressed video data item, thereby generating a compressed video data item (S1010). Furthermore, the sending node 100 generates, from the uncompressed video data item and the compressed video data item, a loss data item that is lost when compression is performed (S1011). The sending node 100 sends the compressed video data item using the LRP (S1015). Furthermore, the sending node 100 sends the loss data item using the HRP (S1025).

The receiving node 110 decompresses the compressed video data item that has been received, thereby generating a decompressed video data item (S1020). Furthermore, because the receiving node 110 succeeds in reception of both the LRP packet and the HRP packet, the receiving node 110 combines the decompressed video data item with the received loss data item (S1030), and outputs, to the display, a combined video data item that has been generated (S1035). The display that has received the video data item replays and displays the combined video data item (S1040).

With the above sequence, when the receiving node 110 correctly receives an LRP and an HRP, replaying of a video having a high quality can be performed by combining a compressed video data item with a loss data item.

In a sequence from S1100 to S1140 illustrated in FIG. 8, a process performed in a case in which the receiving node 110 can correctly receive only an LRP packet is illustrated. Processes in S1100 to S1125 are the same as the processes in S1000 to S1025 illustrated in FIG. 7. In this sequence, the receiving node 110 succeeds in reception of an LRP packet, but fails to receive an HRP packet. Accordingly, the receiving node 110 does not use a loss data item, and outputs, to the display, a decompressed video data item that is obtained by decompressing a compressed video data item (S1135). The display that has received the video data item replays and displays the decompressed video data item (S1140).

With the above sequence, even when the receiving node 110 cannot correctly receive a loss data item using the HRP, a compressed video data item that is simultaneously transmitted using the LRP is utilized, whereby replaying and displaying of a video can be prevented from being interrupted.

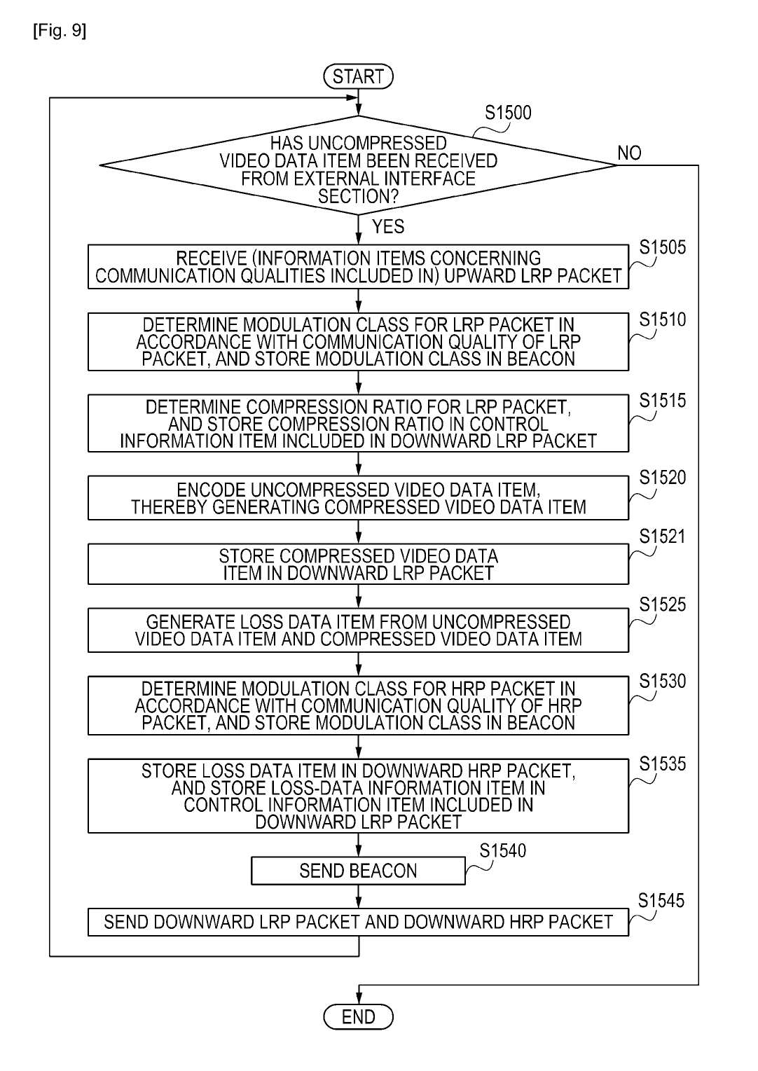

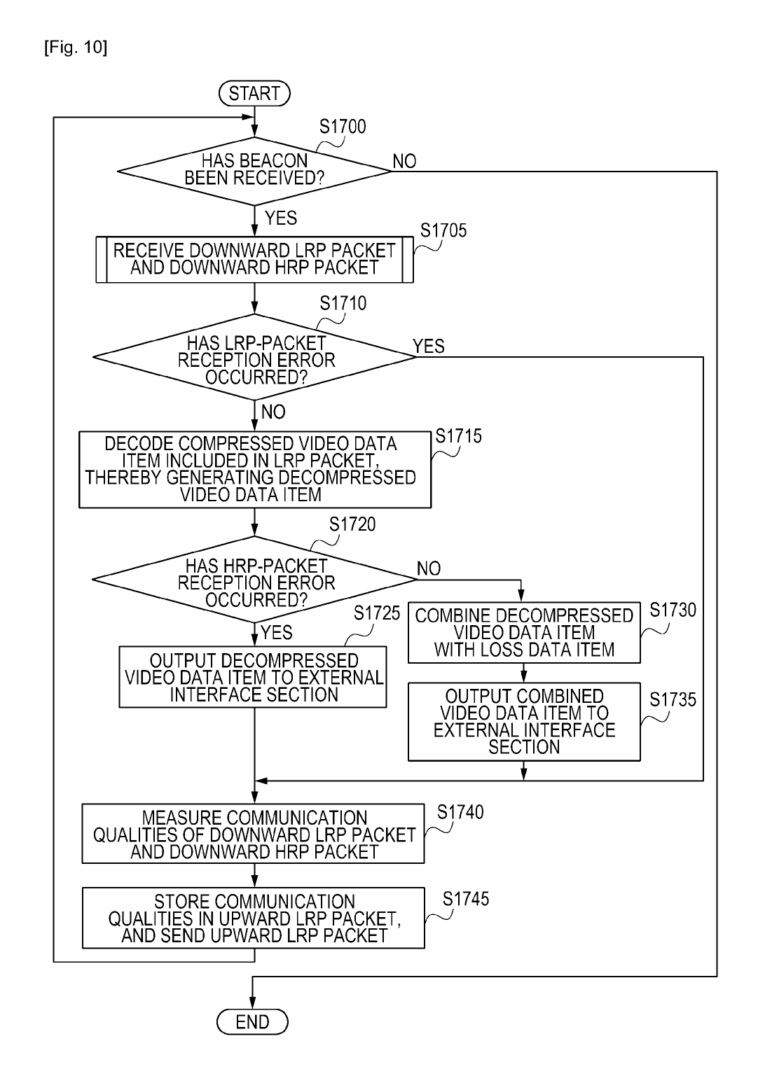

Internal operations of the sending node 100 and the receiving node 110 in a case in which video data items are transmitted will be described with reference to FIGS. 9 and 10.

FIG. 9 is a flowchart illustrating an internal operation of the sending node 100. The operation illustrated in FIG. 9 is performed by executing, with the control section 201, the control program that is stored in the ROM 210.

The sending node 100 determines whether or not video transmission from the data source 105 continues (S1500). When the sending node 100 is receiving an uncompressed video data item via the external interface section 220, the sending node 100 determines that video transmission from the data source 105 continues, and the process branches to S1505. When the sending node 100 is not receiving an uncompressed video data item, the process is terminated. When video transmission continues, the sending node 100 sets the antenna to be in the Wide mode, and receives information items concerning communication qualities, which are included in an upward LRP packet, of a downward LRP packet and a downward HRP packet (S1505). The sending node 100 measures a communication quality of the received upward LRP packet, and determines a modulation class for an upward LRP packet in accordance with the measured communication quality. The sending node 100 stores the modulation class in an access information item included in a beacon. Furthermore, the sending node 100 determines a modulation class for a downward LRP packet in accordance with the received information item concerning a communication quality of a downward LRP packet, and stores the modulation class in an access information item included in the beacon (S1510). The receiving node 110 performs, in accordance with the information item, demodulation of a downward LRP packet. Furthermore, the sending node 100 determines a payload size for a compressed video data item in accordance with the modulation class for a downward LRP packet.

The sending node 100 determines a minimum compression ratio with which a compressed video data item fits in the payload size therefor. Then, the sending node 100 stores a compression-ratio information item in a control information item included in a downward LRP packet (S1515). The receiving node 110 performs decompression of a compressed video data item in accordance with the information item. The sending node 100 compresses the uncompressed video data item with the compression ratio that has been determined in S1515, thereby generating a compressed video data item (S1520). Then, the sending node 100 stores, in the downward LRP packet, the compressed video data item that has been generated (S1521). Furthermore, the sending node 100 generates, from the uncompressed video data item and the compressed video data item, a loss data item that is a data which is lost when compression is performed (S1525). Additionally, the sending node 100 determines a modulation class for a downward HRP packet in accordance with the information item concerning a communication quality of a downward HRP packet, and stores the modulation class in an access information item included in the beacon (S1530). The receiving node 110 performs demodulation of a downward HRP packet in accordance with the information item. Additionally, the sending node 100 determines a payload size for a loss data item in accordance with the modulation class for a downward HRP packet. The sending node 100 extracts a loss data item in such a manner that the loss data item fits in the payload size therefor, and stores the loss data item in a downward HRP packet. In other words, the sending node 100 stores, in a downward HRP packet, a loss data item whose size is determined in accordance with a data rate of the HRP. Moreover, the sending node 100 generates a loss-data information item from the extracted loss data item, and stores the loss-data information item in a control information item included in the downward LRP packet (S1535).

In addition, the sending node 100 sends the beacon using a known modulation class in the Wide mode (S1540). Then, the sending node 100 performs a process of sending the downward LRP packet and the downward HRP packet while performing a control of the antenna directivity (S1545). In the process of sending the downward LRP packet and the downward HRP packet, first, the sending node 100 sets the antenna to be in the Wide mode, and sends the downward LRP packet using the modulation class that is specified in the beacon. Next, the sending node 100 sets the antenna to be in the narrow-directivity mode, sets the antenna to be at a directional angle of the antenna that is specified in the beacon, and sends the downward HRP packet using the modulation class that is specified in the beacon. Note that, in this flowchart, every time a beacon is sent, the size of a loss data item is controlled in accordance with modulation classes for an LRP packet and an HRP packet and an available communication band that are based on communication qualities. However, the data size of a loss data item may be controlled, for example, every time a predetermined time period has elapsed or when the communication qualities change by a large degree.

FIG. 10 is a flowchart illustrating an internal operation of the receiving node 110. The operation illustrated in FIG. 10 is performed by executing, with the control section 305, the control program that is stored in the ROM 310.

The receiving node 110 performs determination of whether or not the receiving node 110 has received a beacon (S1700). When the receiving node 110 has received a beacon, the process branches to S1705. Otherwise, the process is terminated. Note that, in the present embodiment, the receiving node 110 receives a beacon using a known modulation class in the Wide mode. The receiving node 110 receives a downward LRP packet and a downward HRP packet including video data items while performing control of the antenna directivity in accordance with access information items included in the received beacon (S1705). First, the receiving node 110 sets the antenna to be in the Wide mode, and receives a downward LRP packet using a modulation class that is specified in the beacon. Next, the receiving node 110 sets the antenna to be in the narrow-directivity mode, sets the antenna to be at a directional angle of the antenna that is specified in the beacon, and receives a downward HRP packet using a modulation class that is specified in the beacon. Then, the receiving node 110 determines whether or not the downward LRP packet has been received (S1710). When the receiving node 110 has not correctly received the downward LRP packet and a reception error occurs, the process branches to S1740. When the receiving node 110 has correctly received the downward LRP packet, the process branches to S1715. In S1715, the receiving node 110 decompresses, in accordance with a compression-scheme information item and a compression-ratio information item that are stored in control information items included in the downward LRP packet, a compressed video data item included in the downward LRP packet, thereby generating a decompressed video data item. Furthermore, the receiving node 110 determines a state of reception of the downward HRP packet (S1720). When the receiving node 110 has not correctly received the downward HRP packet and a reception error occurs, the process branches to S1725. When the receiving node 110 has correctly received the downward HRP packet, the process branches to S1730. In S1725, in other words, when the receiving node 110 has correctly received the downward LRP packet but has not correctly received the downward HRP packet, the receiving node 110 outputs, to the external interface section, the decompressed video data item that is obtained by decompressing the compressed video data item which has been received using the downward LRP packet. In S1730 (when the receiving node 110 has received the downward LRP packet and the downward HRP packet, and obtained the compressed video data item and a loss data item), the receiving node 110 combines, in accordance with a loss-data information item stored in the control information items included in the downward LRP packet, the decompressed video data item that is obtained by decompressing the compressed video data item with the loss data item, thereby generating a combined video data item. Then, the receiving node 110 outputs the combined video data item to the external interface section (S1735). In S1740, the receiving node 110 measures communication qualities of the downward LRP packet and the downward HRP packet that have been received. Then, the receiving node 110 stores the measured communication qualities in a control information item included in an upward LRP packet. The receiving node 110 sets the antenna to be in the Wide mode, and sends the upward LRP packet using a modulation class that is specified in the beacon (S1745). Note that, although the receiving node 110 notifies the sending node 100 of communication qualities of a downward LRP packet and a downward HRP packet every time the sending node 100 receives a beacon in this flowchart, a timing at which notification of the communication qualities of a downward LRP packet and a downward HRP packet is performed is not limited to the above-described timing. The notification may be performed, for example, every time a predetermined time period has elapsed or when the communication quality of the downward LRP packet or the communication quality of the downward HRP packet changes by a large degree.

In the present embodiment, a configuration is used, in which the receiving node 110 feeds back a communication quality of a downward packet to the sending node 100, and in which the sending node 100 can appropriately control, using the feedback, the size of a loss data item to be transmitted. However, for example, a configuration may be used, in which the receiving node 110 is not caused to feed back the communication quality on a regular basis, and in which the sending node 100 transmits a loss data item in such a manner that the size of the loss data item is a fixed size. Furthermore, although communication paths that are different from each other are applied for the HRP and the LRP by applying antenna directivities that are different each other in the present embodiment, the present invention is not limited thereto. For example, a configuration may be used, in which, without performing control of the antenna directivities, a difference between the characteristics of communication paths are generated simply by applying modulation classes that are different from each other for the HRP and the LRP. Furthermore, in the present embodiment, a configuration may be used, in which, in communication using the HRP and the LRP, multiplexing is performed by one of time division multiplexing, frequency division multiplexing, code division multiplexing, and space division multiplexing. Furthermore, although a video data item is used as an example in the above-described embodiment, any of an audio data item and other data items may be used. Particularly, the present invention is effective to data transmission that requires a real-time property.

As described above, communication paths for the low-rate transmission channel are not easily interrupted, and the sending node transmits a compressed data item using the low-rate transmission channel. A communication path for the high-rate transmission channel is easily interrupted. However, using the high-rate transmission channel, a high gain can be obtained, and a data item can be transmitted at a high rate. The sending node transmits, using the high-rate transmission channel with which a data item can be transmitted at a high rate, a loss data item in such a manner that the size of the loss data item is the maximum size of a data item which can be transmitted. Then, the receiving node combines, with the loss data item, a decompressed data item that is obtained by decompressing the compressed data item, and replays the combined data item. Therefore, a data item having a high quality possible (a high image quality possible) can be replayed. Furthermore, even when the high-rate transmission channel is interrupted, short interruption of replaying of the data item is reduced by utilizing the compressed data item transmitted using the low-rate transmission channel. Thus, the reliability of communication can be improved.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2009-059562, filed Mar. 12, 2009, which is hereby incorporated by reference herein in its entirety.

1. A communication apparatus comprising:
a first communication unit configured to communicate, via a low-rate transmission channel having wide directivity, compressed data that is obtained by compressing data; and
a second communication unit configured to communicate, via a high-rate transmission channel having narrow directivity, loss data that is lost by compression of the data.

2. The communication apparatus according to claim 1, wherein the second communication unit sends the loss data whose size is determined in accordance with a data rate of the high-rate transmission channel.

3. The communication apparatus according to claim 1, wherein communication paths different from each other are applied for the high-rate transmission channel and the low-rate transmission channel.

4. The communication apparatus according to claim 1, wherein the high-rate transmission channel and the low-rate transmission channel perform communication using directional angles, which are different from each other, of antennas.

5. The communication apparatus according to claim 1, wherein the second communication unit delays the loss data by a predetermined time, and sends the loss data.

6. The communication apparatus according to claim 5, wherein the predetermined time is a data compression processing time.

7. The communication apparatus according to claim 1, further comprising a combining unit configured to combine, with the loss data that has been received using the high-rate transmission channel, decompressed data that is obtained by decompressing the compressed data which has been received using the low-rate transmission channel.

8. The communication apparatus according to claim 7, further comprising a determination unit configured to determine a state of reception using the high-rate transmission channel,
wherein the combining unit combines, in accordance with a result of determination by the determination unit, with the decompressed data that is obtained by decompressing the compressed data which has been received using the low-rate transmission channel, the loss data that has been received using the high-rate transmission channel.

9. The communication apparatus according to claim 7, further comprising a delay unit configured to delay, by a predetermined time, the loss data that has been received using the high-rate transmission channel,
wherein the combining unit combines, with the decompressed data that is obtained by decompressing the compressed data which has been received using the low-rate transmission channel, the loss data that has been delayed by the delay unit.

10. The communication apparatus according to claim 9, wherein the predetermined time is a processing time for decompressing the compressed data that has been received using the low-rate transmission channel.

11. The communication apparatus according to claim 7, further comprising an output unit configured to output, in order to display combined data that is generated by the combining unit, the combined data.

12. A method for controlling a communication apparatus, the method comprising:
a first communicating step of communicating, via a low-rate transmission channel having wide directivity, compressed data that is obtained by compressing data; and
a second communicating step of communicating, via a high-rate transmission channel having narrow directivity, loss data that is lost by compression of the data.

13. A non-transitory computer readable medium for controlling a communication apparatus, the computer readable medium causing the communication apparatus to execute:
a first communicating step of communicating, via a low-rate transmission channel having wide directivity, compressed data that is obtained by compressing data; and
a second communicating step of communicating, via a high-rate transmission channel having narrow directivity, loss data that is lost by compression of the data.
